(19) United States
(12) Patent Application Publication
(10) Pub. No.: US 2006/0188637 A1
(43) Pub. Date: Aug. 24, 2006

(54) Raw material for food containing soybean component, food containing soybeam component from the raw material, and process for producing the food containing soybean component

(76) Inventor: Hiroaki Iwamoto, Wakayama (JP)

Correspondence Address: Shlesinger Arkwright & Garvey, 1420 King Street, Suite 600, Alexandria, VA, 22314, US

(21) Appl. No.: 10/549,935

(22) PCT Filed: May 6, 2004
(86) PCT No.: PCT/JP04/05966

§ 371 Date: Sep. 20, 2005

(30) Foreign Application Priority Data
May 6, 2003 (JP) 2003-128250

(51) Int. Cl. A23L 1/20

(52) U.S. Cl. 426/634

(57) ABSTRACT

The present invention provides a food containing soybean component and exhibiting smooth texture even on restoration to ordinary temperature after freeze-up (including lyophilization); the food is produced by mixing a soymilk coagulant (b) capable of coagulating a soymilk-like liquid (a) and a gelling agent (c) capable of gelation of soybean curd components on cooling with a soymilk-liquid (a) as well as mixing a thickening treatment agent (d) derived from yam belonging to Dioscoreacea and/or thickening heat treatment agent (e) derived from cheese whey, optionally together with a shape loss preventing agent (f) derived from an animal protein, thereafter heating the mixture to coagulation temperature of the soymilk coagulant (b) or higher and finally cooling the hot mixture.

### TECHNICAL FIELD

The present invention relates to an ingredient for a food containing a soybean component, a food containing soybean component made of an ingredient such as bean curd, etc., as an ingredient, and production method thereof. That is, it relates to the food containing soybean component such as bean curd, etc., which can be preserved by freeze-up (including preservation by freeze-drying (lyophilization), etc.), particularly, the food containing soybean component such as bean curd, etc., which can be preserved by freeze-up, exhibiting smooth texture even on restoration to its original state by thawing, etc., and the production method thereof, the food containing the other soybean components, and an ingredient of the food containing the soybean components.

### BACKGROUND ART

Bean curd has been familiar with from old times as food having high nutrition, but its low preservation has been a problem. To solve this problem, attempts have been made to preserve it by refrigeration and freeze-drying.

When bean curd is frozen, the free water present inside the curd enters into its air bubbles and freezes therein, soybean proteins get modified, i.e., KOUYA-TOFU (the freeze-dried bean curd) is formed, and food mouthfeel and flavor are lost after thawing. Therefore, the preservation of bean curd by refrigeration is difficult. Moreover, on thawing, the bean curd tends to attain the state wherein “pithy tissue” is formed in its texture and it becomes difficult to obtain unique softness of the bean curd. Therefore, coagulants, starch, saccharides, gums, gelatin, etc., are added to soymilk. Moreover, in the Japanese Patent KOKAI (LOPI) No. HO-271972, a method wherein oligosaccharides and polysaccharides are added has been proposed for the production of freeze-dried bean curd. In the Japanese Patent KOKAI (LOPI) No. HO-191920, a method and apparatus for continuous production of frozen bean curd have been proposed.

### DISCLOSURE OF THE INVENTION

Problem to be Solved by the Invention

Thus, various improvements have been suggested, but each proposed method has indicated therein the difficulty in restoring the original mouthfeel of bean curd (particularly, its softness and mouthfeel without the feeling of granular matter mixed therein).

When the bean curd is freeze-dried, on lyophilization of bean curd by increasing its thickness, cracks develop in it. It is because, on lyophilization, the bean curd forms spongy texture due to the advancement of ice-formation and crystallization of the water content therein, concentration of the constituents, and deformation of the soybean proteins to form net-like structure.

The problems are not limited to bean curd only; they are also seen in the processed foods of bean curd, the processed foods obtained from the ingredient containing bean curd, and the foods obtained from the ingredient containing soybean and water.

For industrial mass production of the frozen OBORO-TOFU (softly formed bean curd) requiring even softer food mouthfeel than ordinary bean curd, unless it is produced by the filling method, it is necessary to cut and remove bean curd from a mold into the desired shape and size before freezing. If attention is paid to softness during this process, its shape is destroyed during cutting and removing bean curd from the mold as a result of which it becomes difficult to obtain the frozen OBORO-TOFU in good form.

In the production of processed foods using bean curd as ingredient, normally, it is used as ingredient after reducing its water content by heating, pressurization, etc. If frozen bean curd with lesser water content as compared to that in ordinary bean curd maintaining its soft mouthfeel on thawing can be obtained, the process of production of the processed foods can be simplified which is preferable.

In view of the above-mentioned conditions, the present invention aims at providing a food containing soybean component and exhibiting soft mouthfeel without “pithy tissue” and feeling of granular matter mixed therein and capable of retaining its original mouthfeel even on thawing after freeze-up (including lyophilization), and an ingredient or raw material for food containing soybean component capable of providing the characteristics to the produced food that even on thawing after freeze-up it maintains the soft mouthfeel without a “pithy tissue” and feeling of granular matter mixed therein.

The present invention aims at providing the food containing soybean component, particularly, OBORO-TOFU, which is softer than ordinary bean curd and can be preserved by freeze-up, exhibiting soft mouthfeel without a “pithy tissues” and feeling of granular matter therein even on restoration to its original state after freeze-up (including lyophilization), the processed food containing soybean component obtained by using the bean curd as ingredient or material, and the other foods containing soybean component.

The present invention aims at providing the food containing soybean, such as very soft bean curd, etc., which can be preserved by freeze-up and processed for obtaining the frozen OBORO-TOFU in good form without shape loss, particularly, when bean curd is used as food containing the above-mentioned soybean component, even when it has to be cut into the desired shape and size before freeze-up.

The present invention aims at providing the food containing soybean component, such as bean curd, etc., which can be preserved by freeze-up (lyophilization) without development of cracks therein even when it is comparatively thicker.

The present invention aims at providing the food containing soybean component, such as bean curd, etc., which can be preserved by freeze-up and used as an ingredient or material for obtaining the processed food without reducing its water content by pressurization, etc., and is capable of exhibiting softness even on restoration to its original state and has lesser water content as compared to ordinary bean curd.

The present invention also aims at providing a process for producing the above-mentioned foods containing soybean component, such as bean curd, etc., which can be preserved by freeze-up.

Means to Solve the Problem

Ingredients for a food containing a soybean component according to the present invention can be produced by mixing a thickening treatment agent (d) derived from yam belonging to Dioscoreacea and/or a thickening heat treatment agent (e) derived from cheese whey with soymilk liquid (a) (claim 1). Optionally a shape loss preventing agent (f) derived from an animal protein can also be mixed with it (claim 2).

According to the present invention, the food containing soybean component, such as bean curd, etc., which can be preserved by freeze-up, can be produced by mixing a soymilk coagulant (b) capable of coagulating soymilk-like liquid (a) and a gelling agent (c) capable of gelation of soybean curd components on cooling with soymilk-like liquid (a) as well as mixing a thickening treatment agent (d) derived from yam belonging to Dioscoreacea and/or thickening heat treatment agent (e) derived from cheese whey, and optionally together with a shape loss preventing agent (f) derived from an animal protein therein, thereafter heating the mixture to coagulation temperature dependent on the soymilk coagulant (b) or higher and finally cooling the hot mixture (claims 3 and 4).

An example of the thickening treatment agent (d) derived from yam belonging to Dioscoreacea is yam component (claim 5). An example of the thickening heat treatment agent (e) derived from cheese whey is whey protein concentrate (WPC) derived from cow's milk “protein coagulating on heating” (claim 6) and an example of the shape loss preventing agent (f) derived from an animal protein is milk serum protein or egg albumin component (claim 7).

When the food containing soybean component, such as bean curd, etc., having soft mouthfeel is produced, the blending ratio of the respective components is for example, 0.01 to 0.08 wt % or preferably 0.05 to 0.3 wt % of the soymilk coagulant (b), 0.05 to 4 wt %, preferably 0.1 to 2 wt % of the gelling agent (c), 0.01 to 4 wt %, preferably 0.04 to 2 wt % of the thickening treatment agent (d) derived from yam belonging to Dioscoreacea, 0.01 to 4 wt %, preferably 0.04 to 2 wt % of the thickening heat treatment agent (e) derived from cheese whey, and 0.01 to 3 wt %, preferably 0.03 to 2 wt % of the shape loss preventing agent (f) derived from an animal protein with respect to 100 wt % of the soymilk-like liquid (a) at a weight of solid in dry state (claim 11).

When the food containing soybean components, such as bean curd, etc., having comparatively harder mouthfeel is produced, the blending ratio of the respective components is for example, 0.3 to 0.8 wt % or preferably 0.4 to 0.6 wt % of the soymilk coagulant (b), 0.05 to 4 wt %, preferably 0.1 to 2 wt % of the gelling agent (c), 0.1 to 3 wt %, preferably 0.5 to 2 wt % of the thickening treatment agent (d) derived from yam belonging to Dioscoreacea, 0.5 to 15 wt %, preferably 1 to 8 wt % of the thickening heat treatment agent (e) derived from cheese whey, and 0.5 to 5 wt %, preferably 1 to 3 wt % of the shape loss preventing agent (f) derived from an animal protein with 100 wt % of the soymilk-like liquid (a) at a weight of solid in dry state (claim 12).

In the method of this invention for producing the food containing soybean component, such as bean curd, etc., which can be preserved by freeze-up, the soymilk-like liquid (a) is heated to 41 to 69° C., a soymilk coagulant (b) capable of coagulating the soymilk-like liquid (a) and a gelling agent (c) capable of gelation of soybean curd components on cooling are mixed with the soybean liquid at the same temperature, and a thickening treatment agent (d) derived from yam belonging to Dioscoreacea and/or a thickening heat treatment agent (e) derived from cheese whey are added at the same temperature, optionally together with a shape loss preventing agent (f) derived from an animal protein, thereafter the mixture is heated to coagulation temperature dependent on the soymilk coagulant (b) or higher and finally the hot mixture is cooled (claims 13 and 14).

Specific examples of the foods of this invention containing soybean component are the the bean curd which can be preserved by freeze-up, as well as the food obtained by mixing ingredients of CHAWAN MUSHI (steamed egg hotchpotch), etc. such as edible meat, sea food, ginkgo nut, green vegetables such as lily bulb, etc., condiments, etc., (Claim, 15); the food obtained by adding condiments, etc., to the bean curd, etc., or kneading the material with edible meat, etc., and then frying or roasting the resultant mixture, i.e., the processed food prepared by using the bean curd as ingredient or material (claims 16 to 24) as well as the food prepared by mixing wheat flour and fresh cream, etc., to the ingredient of the food containing soybean component without adding a soymilk coagulant (b) (claims 25 to 28), etc.

Effect of the Invention

The present invention can provide the food containing soybean component, wherein a thickening treatment agent (d) derived from yam belonging to Dioscoreacea and/or a thickening heat treatment agent (e) derived from cheese whey, i.e., at least one selected from (d) and (e) and, if necessary, a shape loss preventing agent (f) derived from an animal protein are added so as to suitably prevent modification of the soybean proteins therein on preservation by freeze-up (lyophilization) and retain its smooth texture, without deterioration of mouthfeel and flavor due to the modification of soybean proteins, even on restoration to ordinary temperature after freeze-up by thawing, putting in water, etc.

The present invention can provide the bean curd such as OBORO-TOFU, which is softer than ordinary bean curd, as well as the soft bean curd exhibiting hard mouthfeel with lesser water content in comparison to ordinary bean curd, these bean curd products which can be preserved by freeze-up retain good mouthfeel and flavor without the development of “pithy tissue” and the feeling of foreign granular matter therein even on restoration to the original state by thawing.

The present invention can also provide the foods containing soybean component such as bean curd, etc., which do not develop cracks, etc., even when thickness of the bean curd at the time of lyophilization is comparatively larger. Moreover, even if the bean curd is cut into the desired shape and size before freeze-up, it retains excellent form without shape loss.

Therefore, according to the present invention, the food containing soybean component such as bean curd, etc., which can be preserved by freeze-up, if necessary, can be cut and removed the bean curd from the mold into the desired shape before freeze-up and then can be preserved in a fixed shape by freezing and lyophilization.

The soft and smooth frozen bean curd similar to the OBORO-TOFU gives excellent soft mouthfeel even when it is eaten after restoring to its original state and cooking by heating or as such in the refrigeration temperature zone (it has been impossible till now). Moreover, the present invention also provides the new food products containing soybean component and giving the mouthfeel of steamed food obtained by adding various kinds of CHAWAN MUSHI ingredients to the bean curd.

The present invention enables to produce the food containing various bean curd components by using the frozen bean curd with reduced water content as compared to ordinary bean curd and exhibiting hard mouthfeel as an ingredient or materials; the food containing soybean component and giving mouthfeel and flavor similar to those of the food produced from ordinary bean curd can be produced in the same manner as those produced from ordinary bean curd with omitting the heat treatment and pressurization process for removing water from the bean curd.

### PREFERRED EMBODIMENTS OF THE INVENTION

Preferred embodiments of the present invention will be described below.

In the present invention, the term “food containing soybean components” refers to all the foods containing bean curd components such as bean curd. That is, it refers to the foods which can be produced by using the ingredient comprising the soymilk-like liquid (a), at least one of the thickening treatment agent (d) derived from yam belonging to Dioscoreacea and the thickening heat treatment agent (e) derived from cheese whey, and, if necessary, the shape loss preventing agent (f) derived from an animal protein.

In the present invention, the term “bean curd” refers to ordinary MOMEN-TOFU (cotton-strained bean curd), KINUGOSHI-TOFU (silk-strained bean curd) and bean curd having highly smooth mouthfeel called OBORO-TOFU. It also includes the bean curds wherein the water content is reduced as compared to that in ordinary bean curd.

The foods containing soybean component of the present invention are described below with reference to the examples of bean curd which can be preserved by refrigeration.

The bean curd according to the present invention is characterized by comprising the soymilk-like liquid (a), the soymilk coagulant (b) capable of coagulating the soymilk-like liquid (a) and the gelling agent (c) capable of gelation of bean curd components on cooling, and also the thickening treatment agent (d) derived from yam belonging to Dioscoreacea and/or the thickening heat treatment agent (e) derived from cheese whey. It is preferable that the bean curd contains the thickening treatment agent (d) as thickening treatment agent, however the thickening heat treatment agent (e) derived from cheese whey can also be added either in place of the thickening treatment agent (d) or together with it. Moreover, if necessary, the shape loss preventing agent (f) derived from an animal protein can also be added.

In the present invention, the soymilk-like liquid (a) refers to the liquids containing soymilk component. According to the Japanese Agricultural Standard, the liquids containing 8% or more of soybean solid component are defined as soymilk. It is preferable to use the soymilk which conforms to the Japanese Agricultural and Forestry Standard. However, the modified soymilk having 6% or more of the soybean solid component can also be used.

According to the present invention, the liquid obtained by dissolving soybean powder in water can also be used as the soymilk-like liquid (a) as well as the soymilk or soymilk-like liquid obtained by mixing water with soybean and then filtering. The concentrated soymilk obtained by reducing its water content by using the known moisture evaporator, etc., so as to adjust the required ratio of soybean component with suitable elastic force and viscosity therein can also be used. It is preferable that the soybean solid component in the soymilk-like liquid (a) is 8% to 20%.

The soymilk coagulant (b) refers to calcium sulfate, SUMASHI-KO containing calcium sulfate as its main constituent, calcium chloride, magnesium chloride, bittern containing magnesium chloride as its main constituent, or gluconodeltalactone, lactic acid, etc., capable of coagulating the soymilk at the fixed temperature (70 to 95° C.). It is preferable to use 0.01 to 0.8 wt % of the soymilk coagulant with respect to 100 wt % of the soymilk-like liquid. However, for the production of soft bean curd such as OBORO-TOFU, it is preferable to use its lesser quantity, i.e., less than 0.3 wt %. Moreover, for the production of the bean curd with hard mouthfeel and reduced water content, it is preferable to use 0.3 to 0.8 wt %, preferably 0.4 to 0.6 wt % of the soymilk coagulant.

The gelling agent (c) refers to the substances which are capable of gelation of soybean curd components on cooling. Specific examples of the gelling agent are given below; they can be used individually or in combination of them.

For example, the gelling agents include (1) proteins such as gelatin, casein, etc.; (2) seaweed polysaccharides such as agar, KARAGIINAN, FAASERURAN, ARUGIN, etc., (3) polysaccharides from microbial source, seed polysaccharides and sap polysaccharides such as xanthane gum, tamarind gum, gum arabic, guar gum, locust bean gum, etc., (plant gum is the general term used for them); the other polysaccharides such as pectin, KONNYAKU-MANNAN, etc. As indicated in the Japanese Patent KOKAI(LOPI) No. S61-163963, it is preferable to use highly water-soluble gelatin as gelling agent; it can be prepared by spraying gelatin solution on the fluidized gelatin powder.

A thickening treatment agent gets modified on heating and produces the thickening effect. According to the present invention, the thickening treatment agent (d) derived from yam belonging to Dioscoreacea and/or the thickening heat treatment agent (e) derived from cheese whey should be used.

When the thickening treatment agent (d) derived from yam belonging to Dioscoreacea is heated to 70° C. or more, it gets modified and produces the coagulating effect; the thickening effect is produced by the glycoprotein and mucopolysaccharides present therein.

The thickening heat treatment agent (e) derived from cheese whey corresponds to the whey protein obtained from the byproduct (called sweet whey) formed during the production of cheese from cow's milk, etc. It is used in the form of the sweet whey or whey protein concentrate (WPC) obtained by concentrating the sweet whey. The whey protein concentrate (WPC) “heat coagulating protein” derived from the cow's milk can be used as the thickening heat treatment agent (e) derived from cheese whey.

Conventionally, starch such as corn starch, Irish potato starch, etc., were being used. However, the inventors discovered that the thickening treatment agent (d) derived from yam belonging to Dioscoreacea and the thickening heat treatment agent (e) derived from cheese whey could produce the thickening effect to the food containing soybean component such as bean curd, etc., retaining its softness. When the thickening agents are added to bean curd and the other foods containing soybean component, the food products exhibit excellent smoothness like that of OBORO-TOFU even on restoration to the original state after freeze-up (lyophilization) by thawing, putting in water, etc. They can also provide pleasant smoothness to the food containing soybean component with hard mouthfeel and strong gelling strength.

That is, when the conventional starch substances are heated to 70° C. or more, the saccharides present therein get modified and become hard. On the contrary, the thickening treatment agent (d) derived from yam belonging to Dioscoreacea and the thickening heat treatment agent (e) derived from cheese whey are capable of maintaining softness even under the same heating conditions. Particularly, mucopolysaccharides has excellent characteristics to maintain softness and viscosity on heating.

Specific examples of the yam belonging to Dioscoreacea are yam, Japanese yam, Chinese yam, ICHINEN-IMO, ICHYO-IMO, ISE-IMO, YAMATO-IMO, etc. They can be added in powder status. However, it is preferable to mix them with the soymilk-like liquid (a) in the form of solution.

The thickening treatment agents (d) and (e) obtained in the form of starch powder from the natural yam belonging to Dioscoreacea and the cheese whey respectively and the products obtained by treating them chemically or physically can be used.

The thickening treatment agent (d) derived from yam belonging to Dioscoreacea and the thickening heat treatment agent (e) derived from cheese whey can be used individually or in combination thereof. According to the present invention, for maintaining smoothness of the food product suitably, it is preferable to add, particularly, the thickening treatment agent (d) derived from yam belonging to Dioscoreacea.

For the production of a very soft bean curd such as OBORO-TOFU, 0.01 to 4 wt %, preferably 0.04 to 2 wt % of the thickening treatment agent (d) derived from yam belonging to Dioscoreacea and/or the thickening heat treatment agent (e) derived from cheese whey can be added with respect to 100 wt % of the soymilk-like liquid.

For the production of the bean curd with hard mouthfeel and reduced water content, it is preferable to increase the blending ratio of the thickening treatment agents (d) and (e) and that of the shape loss preventing agent (f) derived from an animal protein and increase the solid component therein. For example, the blending ratio of each of the thickening treatment agents (d) and the thickening heat treatment agent (e) is 0.1 to 15 wt %, preferably 0.5 to 8 wt % with respect to 100 wt % of the soymilk like liquid.

The shape loss preventing agent (f) derived from an animal protein improves binding properties of the bean curd component; particularly, after cooling the food product containing soybean component such as bean curd, etc., it prevents its shape loss during the processes such as cutting, die-cutting, taking out from the mold, etc.

The specific examples are milk serum protein and egg albumin component; their mixture can also be used. The milk serum protein and egg albumin component can be added in powder form. However, it is preferable to mix their solution with the soymilk-like liquid (a).

The shape loss preventing agent derived form the milk serum protein differs from the thickening heat treatment agent derived from cheese whey. For example, the shape loss preventing agent derived form the milk serum protein is the whey protein obtained from the byproduct (called acid whey) formed during the production of casein or cottage cheese from raw milk such as cow's milk, etc. It can be used in the form of the acid whey or in the form of whey protein concentrate (WPC) obtained by concentrating the acid whey. The shape loss preventing agent derived form the milk serum protein forms strong gel in pure water; it can improve binding properties of the soybean component and effectively prevent shape loss of the food product.

For the production of highly soft bean curd such as OBORO-TOFU, 0.01 to 3 wt %, preferably 0.03 to 2 wt % of the shape loss preventing agent (f) derived from an animal protein with respect to 100 wt % of the soymilk-like liquid can be used and, for the production of the bean curd with hard mouthfeel and reduced water content, the blending ratio of the shape loss preventing agent may be 0.5 to 5 wt %, preferably 1 to 3 wt % with respect to 100 wt % of the soymilk-like liquid.

For the production of the other foods containing soybean components, each component (a) to (f) can be used in the same manner as illustrated in the above-mentioned execution models.

When explaining the blending ratio of each component (a) to (f), for example, for the production of the highly soft foods containing soybean component such as OBORO-TOFU, it will be preferable to use them in the ratio as given below. However, the mixing ratio is not limited to this embodiment;

With respect to 100 wt % of the soymilk-like liquid, 0.01 to 0.8 wt % (preferably 0.05 to 0.3 wt %) of the soymilk coagulant (b), 0.05 to 4 wt % (preferably 0.1 to 2 wt %) of the gelling agent (gelatin) (c), 0.01 to 4 wt % (preferably 0.04 to 2 wt %) of the thickening treatment agents (d), 0.01 to 4 wt % (preferably 0.04 to 2 wt %) of the thickening heat treatment agents (e), and 0.01 to 3 wt % (preferably 0.03 to 2 wt %) of the shape loss preventing agent (f) can be used.

The weight of each component (b) to (f) given above corresponds to their respective weight in dry solid state. According to the present invention, the food softer and thicker than ordinary bean curd can be obtained by blending lesser quantity of the soymilk coagulant (b) and, at the same time, blending the yam component as the thickening treatment agents (d). However, when large quantity of the yam component is blended, binding properties of the bean curd component deteriorate as a result of which shape of the product is lost on processing it by cooling the bean curd. Soft and slippery mouthfeel of the food can be maintained and its processing characteristics can be improved by mixing the shape loss preventing agent (f) derived from an animal protein such as milk serum protein, egg albumin component, etc.

Now, when explaining the blending ratio of each component, for example, for the production of the bean curd with hard mouthfeel and reduced water content in comparison to those of ordinary bean curd, it will be preferable to use them in the ratios as given below; With respect to 100 wt % of the soymilk-like liquid, at the weight in dry solid state, 0.3 to 0.8 wt %, preferably 0.4 to 0.6 wt % of the soymilk coagulant (b), 0.05 to 4 wt %, preferably 0.1 to 2 wt % of gelatin as a gelling agent (c), 0.1 to 3 wt %, preferably 0.5 to 2 wt % of the thickening treatment agents (d), 0.5 to 15 wt %, preferably 1 to 8 wt % of the thickening heat treatment agents (e), and 0.5 to 5 wt %, preferably 1 to 3 wt % of the shape loss preventing agent (f) can be used.

The weight of each component (b) to (f) given above corresponds to their respective weight in dry solid state. In the above-mentioned example, the blending ratios of the thickening treatment agents (d) and (e) and/or the shape loss preventing agent (f) are high and the solid component therein is increased. Therefore, the water content therein is reduced and water-holding capacity and gelling strength improve due to the thermal gelling reaction at 70° C. or more. In this manner, it becomes possible to obtain the bean curd with hard mouthfeel without any water separation from it and retaining the state of the conventional bean curd existing after draining water from it.

For the production of the bean curd with hard mouthfeel, the soymilk-like liquid obtained after reducing its water content using water evaporator, etc., and adjusting its concentration can be used as the soymilk-like liquid (a).

The method of this invention for the production of bean curd which can be preserved by refrigeration will be described below.

At first, the soymilk coagulant (b) and the gelling agent (c) capable of gelation and fixation of bean curd components on cooling are mixed with the soymilk-like liquid (a), additionally, in the resultant mixture, the thickening treatment agent (d) derived from yam belonging to Dioscoreacea and/or the thickening heat treatment agent (e) derived from cheese whey, optionally together with the shape loss preventing agent (f) derived from an animal protein are mixed.

While mixing the components (b) to (f), temperature of the soymilk-like liquid (a) is kept at or below the temperature of its coagulation by the soymilk coagulant (b). For thorough mixing of the thickening treatment agents (d) and (e), it is preferable to maintain temperature of the soymilk-like liquid (a) at 41 to 69° C.

The mixing can be carried out by the batch-mode method wherein each component is put into the prescribed mold and then the subsequent heating process is performed or by the continuous method wherein each component (a) to (f) is put on a conveyer and the subsequent heating process is performed by moving it. If the production is carried out by following the continuous production method described in the Japanese Patent KOKAI (LOPI) No. H10-191920, the process can be performed at or above 70° C.

After thorough mixing of the components (a) to (f), the resultant mixture is heated at or above the temperature of coagulation (almost 80° C.) by the soymilk coagulant. It enables to coagulate the soymilk-like liquid and obtain the bean curd. Next, the resultant bean curd is cooled to carry out gelation of the soybean curd components by the gelling agent (c). The suitable cooling temperature is 0° C. to 10° C., but the cooling temperature may be changed appropriately if the gelation can be carried out.

Next, if required, the resultant bean curd is removed from the mold and cut. As binding properties of the soybean components are improved by the shape loss preventing agent (f), a shape of the bean curd is not lost even on cutting, etc. If the method to coagulate the component in the state of which the components are filled in specified molds and containers, the cooling and refrigeration can be carried out retaining the food product in the mold and container.

Finally, the frozen bean curd can be obtained by refrigeration in the refrigerator, etc. Moreover, the lyophilized (freeze-dry) bean curd can be obtained by drying it.

As the bean curd of this invention contains at least the thickening treatment agent (d) derived from yam belonging to Dioscoreacea or the thickening heat treatment agent (e) derived from cheese whey, and optionally, the shape loss preventing agent (f) derived from an animal protein, modification of the soybean proteins is suitably prevented even during its preservation by refrigeration, etc., and its soft mouthfeel is retained without the formation of any spongy tissue even when it is restored to its original state by thawing, heating, putting in water, etc.

When one eats the conventional frozen bean curd at its refrigeration temperature (about 0 to 10° C.), it gives crispy mouthfeel because the gelling agent and starch, etc., used as thickening treatment agent harden due to their modification on heating. Therefore, generally, it is eaten after cooking by heating once after restoring to its original state.

On the contrary, as the bean curd of this invention preserved by refrigeration contains the thickening treatment agent (d) derived from yam belonging to Dioscoreacea and the thickening heat treatment agent (e) derived from cheese whey, which are capable of maintaining softness on heating, it gives slippery mouthfeel without any crispy feeling even at the refrigeration temperature after restoration to its original state by thawing, etc.

Therefore, the bean curd of this invention preserved by refrigeration can be served as such in the form of iced tofu and also as dessert food discussed later. Thus, the mouthfeel of soft OBORO-TOFU is obtained.

When the bean curd of this invention which can be preserved by refrigeration is freeze-dried, the freeze-dried bean curd, whether it contains any other ingredient or not, can be used for preparing soup, noodles and cooked food with the new mouthfeel of bean curd by putting it in soup and on noodles, cooked food, etc.

As the bean curd of this invention which can be preserved by refrigeration contains lesser water as compared to ordinary bean curd, on restoring to its original state, it maintains soft mouthfeel and gives the hard mouthfeel similar to that in the state wherein the water is drained. Therefore, it can be used as such, without again reducing its water content by heating and pressurization, as ingredient or material for the preparation of bean curd processed food.

That is, the bean curd with hard mouthfeel contains more solid components as compared to ordinary bean curd; possesses new characteristics provided by the thickening treatment agent (d) derived from yam belonging to Dioscoreacea, the thickening heat treatment agent (e) derived from cheese whey and the shape loss preventing agent (f) derived from an animal protein; remains in the state similar to that of the conventional bean curd obtained by draining water; and possesses the freezing characteristics without water separation even when used for kneading to prepare the processed food. Therefore, it can be easily used for mass production of the soybean processed foods.

The other foods of this invention containing soybean components are explained below with reference to the concrete examples. The foods containing soybean components include wide variety of food products produced by using the basic material of the food containing soybean components obtained, as mentioned earlier, by mixing with the soymilk-like liquid (a) the thickening treatment agent (d) derived from yam belonging to Dioscoreacea and/or the thickening heat treatment agent (e) derived from cheese whey and, optionally, the shape loss preventing agent (f) derived from an animal protein. However, they are not limited to the examples given below. Moreover, blending ratio of the ingredient or material in the under-mentioned food products can be suitably changed.

(1) CHAWAN MUSHI-like food

Preparation of a CHAWAN MUSHI-like food obtained by mixing the ingredients of CHAWAN MUSHI such as edible meat, sea food, gingko nut, green vegetables such as lily bulb, etc. and condiment, etc., in the bean curd of this invention which can be preserved by refrigeration will be described here.

First, each component (a) to (f) is mixed with the ingredients before heating in the ratio as specified for the production of soft bean curd such as the OBORO-TOFU. When mixing, the ingredients can be arranged beforehand on a conveyer or in molds and then each component be added therein or each component and the ingredients can be added simultaneously or the ingredients can be added after putting each component therein. The container used as the end product (for example, cup type container) or the container for processing which is different from that of the end product can be used as the mold.

After putting the ingredient and each component, the resultant mixture is heated to coagulate the soymilk. Subsequently, cooling, cutting and die-cutting (not required when the container is used as mold), refrigeration, and lyophilization can be carried out in the same manner as described in the previous example. In each example, it is preferable to maintain temperature of the soymilk-like liquid at the time of mixing of each component at 41 to 69° C. After mixing, the mixture can be cooled once up to 10 to 0° C. and then can be heated up to the coagulation temperature. At the time of adding the ingredients, it is not necessary to maintain temperature of the soymilk-like liquid at 41 to 69° C.; the ingredients can be added at the stage wherein the mixture is cooled up to 10 to 0° C. The ingredients to be used can be heated beforehand or be in the raw or freeze-dry condition appropriately.

The food produced in this manner can be restored to its soft mouthfeel by rapid thawing in a microwave, natural thawing or by simple heating and new food similar to CHYAWAN MUSHI, wherein the bean curd is used as ingredient or material, can be provided.

(2) Dessert Food

According to the present invention, dessert type foods containing soybean component can be provided by bringing in soft mouthfeel of the bean curd which can be preserved by refrigeration.

Concretely, liquids such as fruit juice, cow's milk, etc., powdered fruit juice products and dairy products are added in addition to the components (a) to (f) while preparing the bean curd with soft mouthfeel. The ingredients used in desserts such as fruits, etc., can also be added. The production method is practically the same as that used for the production of CHYAWAN MUSHI-like food. Desserts can also be provided in the refrigerated and freeze-dry forms. Thus new desserts having soft mouthfeel and containing the bean components can be provided.

(3) The foods containing soybean component prepared by using bean curd which can be preserved by refrigeration, i.e., the bean curd with hard mouthfeel and reduced water content in comparison to ordinary bean curd (hereafter, referred to as “hard bean curd”) are explained below.

(3-1) Bean Curd—Meat Dumplings

The ingredients are 130 g hard bean curd, 130 g chicken mince (the mince obtained by chopping once with 4.5 mm chopper), 2.9 g salt, 10 g bread crumb, 10 g onion (cut into tiny pieces), 0.4 g white pepper, 0.4 g garlic and 28 g egg albumin.

Procedure of preparation: First, salt is added to chicken mince and blended until the production of stickiness and then bread crumb, onion, white pepper and garlic are added and the resultant mixture is blended uniformly. Next, hard bean curd is added and blended until it is finely clashed and then egg albumin is added and blended and finally the product is formed into the desired shape and fried at 160° C. for 3 minutes.

(3-2) Bean Curd Sausage

The ingredients are 130 g hard bean curd, 130 g chicken mince (the mince obtained by chopping once with 4.5 mm chopper), 2.9 g salt, 10 g bread crumb, 10 g onion (cut into tiny pieces), 0.4 g white pepper, 0.4 g garlic and 58 g egg albumin.

Procedure of preparation: First, salt is added to chicken mince and blended until the ingredients become sticky and then bread crumb, onion, white pepper and garlic are added and the mixture is blended uniformly. Next, hard bean curd is added and blended until it is finely clashed and then egg albumin is added and blended and finally the product is formed into the desired shape. The resultant product is dried at 80° C. for 20 minutes, smoked at 70° C. for 10 minutes and then steamed at 75° C. for 20 minutes.

(3-3) Bean Curd Hamburger

The ingredients are 40 kg hard bean curd, 20 kg beef mince (the mince obtained by chopping with 4.2 mm chopper), 10 kg onion, 2 kg bread crumb, 0.5 kg starch, 0.5 kg sugar, 0.5 kg salt, 0.1 kg pepper and 0.1 kg nutmeg.

Procedure of preparation: Hard bean curd and onion are cut to mince with the respective silent cutters and then the above-mentioned ingredient is mixed in a mixer. The resultant mixture is formed into the desired shape (in this case, 80 g/piece), roasted on each side for 1 minute on hot plate at 180° C., steamed for 15 minutes and then sterilized by heating.

(3-4) Bean Curd Mince Cutlet

The ingredients are 40 kg hard bean curd, 20 kg beef mince (the mince obtained by chopping with 4.2 mm chopper), 10 kg onion, 1 kg bread crumb, 0.5 kg starch, 0.5 kg sugar, 0.3 kg salt, 0.1 kg pepper and 0.1 kg nutmeg.

Procedure of preparation: Hard bean curd and onion are cut to mince with the respective silent cutters and then the ingredients are mixed in a mixer. The resultant mixture is formed into the desired shape (in this case, 50 g/piece), and batter is applied on it. The batter used herein is obtained by blending 10 kg batter powder in 35L cold water and then stirred for 4 minutes in a stirrer. After applying batter, bread crumb is applied on it and then the product is refrigerated at −35° C. (at this point, it is 80 g/piece).

Before eating, the preparation is fried in vegetable oil-fat at 170° C. for 4 minutes.

(3-5) Bean Curd Nugget

Hard bean curd is cut into suitable size easy to eat (in this case, 18 g/piece) and powdered then a batter is applied on it. Batter liquid can be prepared by mixing 30L cold water, 20 kg batter powder and 1.5L vegetable oil-fat; various spices such as Parmesan cheese, basil, garlic curry powder, etc., can be added to the batter liquid. Standard quantity of the spices is 1 to 10% of the batter powder. The resultant preparation is pre-fried in vegetable oil-fat at 170° C. for 2 minutes and then refrigerated rapidly at −35° C. for 20 minutes. If the refrigeration temperature is maintained to −30° C. or lower, the preparation can be preserved for 1 year.

Before eating, the above-mentioned bean curd nuggets are fried again in vegetable oil-fat at 170° C. for 4 minutes. When using a microwave, the 100 g preparation is heated for 1 minute and 30 seconds in 600W microwave and 2 minutes and 10 seconds in 500W microwave.

(3-6) Bean Curd Fry

Hard bean curd is cut into suitable size easy to eat (in this case, 20 g/piece) and powdered then a batter is applied on it. Batter liquid can be prepared by mixing 35L cold water and 10 kg batter powder. Next, bread crumb is applied and the resultant preparation is refrigerated rapidly at −35° C. for 20 minutes (at this point, 30 g/piece). If the refrigeration temperature −30° C. or lower is maintained, the preparation can be preserved for 1 year.

Before eating, the preparation is fried in vegetable oil-fat at 170° C. for 3 to 4 minutes.

(3-7) Fried Bean Curd Sticks

Hard bean curd is cut into suitable size easy to eat (in this case, 8 g/piece) and then soaked into 3% salt water for 5 minutes. When the bean curd is put into salt water, its surface reacts with magnesium chloride and becomes harder as a result of which its mouthfeel becomes better. On applying suitable flavor, it becomes delicious.

Next, the liquid is drained (in the case of continuous operation on line, hot air drying can be carried out) and the preparation is fried in vegetable oil-fat at 170° C. for 3 to 4 minutes. On frying in oil, surface of the bean curd becomes savory and hard. After that, oil is drained and the preparation is rapidly refrigerated at −35° C. for 20 minutes. If the refrigeration temperature is maintained to −30° C. or lower, the preparation can be preserved for 1 year.

Before eating, the above-mentioned 100 g fried bean curd sticks are heated for 1 minute and 30 seconds in 600W microwave and 2 minutes and 10 seconds in 500W microwave. On warming in microwave, the water content is evaporated and the mouthfeel is improved.

(3-8) Baked Bean Curd Sticks (Chips)

Hard bean curd is cut into the desired shape such as sticks, sliced chips, etc., oil-fat and condiments are applied and then roasted in fry pan, grill, etc. Flavoring of surface of the preparation is easier than that in the case of the frying method used in (3-7) and quantity of the oil-fat content therein is also controlled.

In the case of mass production, butter, oil, other condiments, etc., can be sprayed on the preparation with arranging it on the net-type belt-conveyer and then roasting can be carried out by heating (for example, using hot air) it from 4 sides using the heating and roasting process (a kind of heat tunnel).

Condiments, etc., can be applied before roasting the hard bean curd as described above. However, they can be applied after roasting also. Moreover, the condiments such as garlic, salt mouthfeel, vegetable powder, etc., can be added to the hard bean curd at the stage of its production and the resultant hard bean curd can be used as an ingredient for the production of the baked bean curd sticks.

(3-9) Bean Curd Steaks

The ingredients are hard bean curd, 3 large spoonfuls of salad oil, 3 large spoonfuls of butter, 3 large spoonfuls of soy, 1 red pepper, 100 g maitake, 100 g mushroom and 10 g garlic. Hard bean curd is cut beforehand into steaks of the desired size (80 mm long×100 mm wide×25 mm height, 200 g/piece).

The hard bean curd (if the bean curd is frozen, it is subjected to thawing) is put into fry pan provided with salad oil, roasted on both sides over medium heat until it becomes brown and then filed into container. Next, butter (1 large spoonful) is put into the fry pan, garlic cut into thin pieces and red pepper broken into small pieces are fried, when smell starts coming, maitake and edible mushroom are added and fried untilwilted, the remaining butter and soy are added and the resultant mixture is applied on the bean curd filled into the container.

As the hard bean curd of the present invention with reduced water content is used as ingredients or materials for preparing the foods containing bean curd component as described above under sections from (3-1) to (3-9), the foods can be prepared easily without going through the process of removing water from the bean curd by heating and pressurization as required in the case of the ordinary bean curd.

As the hard bean curd can endure refrigeration and retain its softness on restoration to its original state after refrigeration or lyophilization, it can be preserved by refrigeration and only the required quantity can be taken out at the time of preparing the above-mentioned foods, restored to the original state by thawing, etc., and used as ingredients or material. Thus, its workability is excellent. For using the bean curd preserved by refrigeration, either it can be put into fridge a day before or thawed by heating in microwave, etc., just before using.

The bean curd preserved by refrigeration, etc., as described above, can be used after restoring to its original state by thawing, etc. However, the manufactured bean curd in its raw state before preservation can also be used as ingredients or materials for production of the foods containing bean curd.

The processed foods obtained by using ordinary bean curd as ingredients or material cannot be preserved by refrigeration because the bean curd present therein gets modified during refrigeration as a result of which the food becomes dry and tasteless during refrigeration. However, as the bean curd of this invention, as discussed above, is capable of withstanding refrigeration and effectively preventing the modification of soybean proteins during refrigeration, etc., the processed foods obtained by using the bean curd as ingredients or material are also capable of withstanding refrigeration. Thus, when the foods are preserved by refrigeration, no modification due to refrigeration takes place therein and, even on restoration to the original state by thawing, the foods give delicious taste.

The foods containing the bean curd component of this invention can be preserved for a long time by refrigeration. For example, the foods preserved at −30° C. or lower for 1 year do not loose their mouthfeel and flavor.

(4) Now, the foods containing soybean components produced by using the ingredients obtained by mixing the thickening treatment agent (d) derived from yam belonging to Dioscoreacea and/or the thickening heat treatment agent (e) derived from cheese whey and, optionally, the shape loss preventing agent (f) derived from an animal protein with the soymilk-like liquid (a) without using the soymilk coagulant (b) and the gelling agent (c) are explained.

Hereafter, the basic ingredients (or simply the “ingredients”) of the foods containing soybean component comprising the soymilk-like liquid (a), the thickening treatment agent (d) derived from yam belonging to Dioscoreacea and/or the thickening heat treatment agent (e) derived from cheese whey and, optionally, the shape loss preventing agent (f) derived from an animal protein will be called the “soybean paste”.

(4-1) Soybean Paste UDON (Japanese Wheat Noodle)

The ingredients are 50 kg soybean paste, 150 kg wheat flour (medium-strength flour), 4 kg salt and 8 kg water.

Procedure of preparation: First, the wheat flour and soybean paste are put into mixer and mixed thoroughly for 10 to 15 minutes. The salt water obtained by mixing salt with water is added little by little during the mixing process. When it becomes quite sticky, round lumps are made out of it which in turn are spread into thin layers of the desired size (for example, 3 mm thick and 400 mm wide) by using roller. After that cutting (5 mm wide) is done by a shearing machine, the noodles formed are boiled in boiling water at 98° C. for 10 to 15 minutes, put in a basket to drain water, chilled by cold water, water is drained and then measuring the weight of the noodle is carried out (200 g/bowl).

Normally, for preparing UDON, water, medium-strength flour and salt are mixed well. However, according to the method of this invention, as the soybean paste contains water, wheat flour is mixed with the paste using its water content. As the soybean paste has unique stickiness, body required for UDON is sufficiently produced in UDON even without carrying out the normal process called ‘ferment’. Therefore, the new method can be used for continuous production of UDON.

Conventionally, in the plants for the mass production of UDON, tapioca starch is used for obtaining sufficient body. The soybean paste can be used as substitute of tapioca starch.

Soybean paste carries good image from the health point of view and has the merit that plant proteins can be taken by eating UDON.

The soybean paste of this invention is capable of withstanding refrigeration and effectively preventing the modification of the contained soybean proteins during refrigeration, etc. Therefore, even when the UDON is preserved by refrigeration, no modification due to refrigeration takes place therein and, even on restoration to the original state by thawing, it gives delicious taste.

(4-2) Soybean Paste Pasta

The ingredients are 150 kg soybean paste, 200 kg wheat flour (strong flour), 100 kg wheat flour (weak flour), 3.3 kg salt and 30 kg olive oil.

Procedure of preparation: The above ingredients are kneaded thoroughly. When the mixture becomes quite sticky, round lumps are made out of it which in turn are spread into thin layers of the desired size (1 to 2 mm thick and 400 mm wide) by using a roller. After that cutting (8 to 10 mm wide) is done by a shearing machine, the resultant product is boiled in boiling water at 98° C. for 3 to 5 minutes After putting in a basket, the product is chilled by cold water and then water is drained.

The pasta prepared in this manner has unique stickiness, like the above-mentioned UDON and body required for UDON is sufficiently produced in it even without carrying out the normal process called ‘ferment’. Therefore, the new method can be used for the continuous production of pasta.

Soybean paste carries good image from the health point of view and has the merit that plant proteins can be taken by the eating pasta.

The soybean paste of this invention is capable of withstanding refrigeration and effectively preventing the modification of the contained soybean proteins during refrigeration, etc., Therefore, even when the the pasta is preserved by refrigeration, no modification due to refrigeration takes place therein and, even on restoration to the original state by thawing, it gives delicious taste.

(4-3) Soybean Paste Chinese Noodles

The ingredients are 50 kg soybean paste, 150 kg wheat flour (medium-strength flour), 4 kg salt, 8 kg water and 5.3 kg KANSUI (bittern).

Procedure of preparation: First, the wheat flour and soybean paste are put into mixer and mixed thoroughly for 10 to 15 minutes. The salt water obtained by mixing salt with water and KANSUI are added little by little during the mixing process. When it becomes quite sticky, round lumps are made out of it, which in turn are spread into thin layers of the desired size (3 mm thick and 400 mm wide) by using a roller. After that cutting (3 mm wide) is done by a shearing machine, the noodles formed are boiled in boiling water at 98° C. for 10 to 15 minutes, put in a basket to drain water, chilled by cold water, water is drained and then measuring the weight (180 g/bowl).

The Chinese noodles prepared in the above-mentioned manner have the same effect as the UDON described earlier. That is, normally, for preparing the Chinese noodles, water is mixed with wheat flour and salt are mixed well. However, according to the method of this invention, as the soybean paste contains water, wheat flour is mixed with the soybean paste using its water content.

As the soybean paste has unique stickiness, body required for UDON is sufficiently produced in the Chinese noodles can be obtained without carrying out the normal process called ‘ferment’. Therefore, the new method can be used for the continuous production of Chinese noodles.

Conventionally, in the plants for the mass production of Chinese noodles, tapioca starch is used for obtaining sufficient body. The soybean paste can be used as substitute of tapioca starch.

Soybean paste carries good image from the health point of view and has the merit that plant proteins can be taken by eating Chinese noodles.

The soybean paste of this invention is capable of withstanding refrigeration and effectively preventing the modification of the contained soybean proteins during refrigeration, etc., Therefore, even when the Chinese noodles are preserved by refrigeration, no modification due to refrigeration takes place therein and, even on restoration to the original state by thawing, the Chinese noodles give delicious taste.

(4-4) Soybean Paste Ice Cream

The ingredients are 100 g soybean paste, 80 ml fresh cream, albumin of 2 eggs and 40 g sugar.

Procedure of preparation: First, fresh cream is beaten in eggbeater. Egg albumin is also beaten in eggbeater and sugar is added on the production of fine froth. Cream is added to the egg albumin, soybean paste is thoroughly mixed with it and the resultant mixture is filled into container and frozen at −30° C. for 5 hours.

Normally, for the production of bean-curd ice cream, the bean curd is finely clashed to form paste and then processed to obtain the ice cream. The process is very time-consuming and costly. The soft paste obtained by enzyme-degradation of bean curd is also used. However, as the preparation is not creamy, soybean granules give disliking taste on eating the ice cream.

As the soybean paste of this invention used for the preparation of ice cream is capable of effectively preventing the modification of the contained soybean proteins during refrigeration, etc., the resultant ice cream is slippery and gives delicious taste.

### EMBODIMENTS

Execution examples of the bean curd, which can be preserved by refrigeration, of this invention are explained below together with the comparison examples. However, the present invention is not limited to these examples only.

Various samples of the bean curd of the thickness given in Table 1 were obtained by mixing the specified weight parts of each component used in the execution and comparison examples as given in Table 1 with respect to 100 wt % of the soymilk at about 60° C., stirring the resultant mixture and then heating it to 75° C. to coagulate the soymilk. The resultant samples were cooled up to 20° C. using cold water, cut into 5 cm×5 cm rectangular pieces and frozen in freezing compartment at −40° C. Half of the obtained refrigerated bean curd was dried at 70° C. for 24 hours to obtain the freeze-dry bean curd.

The obtained refrigerated bean-curd samples were thawed in hot water and the obtained freeze-dry bean curd was dipped in hot water and then examined to see their state and mouthfeel. Mouthfeel was judged by 10 panelists.

The obtained results are shown in Table 2. Excluding the FD dryness, the evaluation was carried out by the 5-grades method wherein A, B, C, D and E correspond to very good, good, normal, bad and very bad respectively. “Refrigeration” and “FD” show the mouthfeel of refrigerated bean curd and the mouthfeel of the freeze-dry bean curd respectively.

Further evaluation was carried out by examining the “FD Dryness”, wherein whether the drying (Freeze drying) was possible or not was found out under the above-mentioned conditions; in the evaluation method, A and B correspond to ‘possible’ and ‘not possible’ respectively.

“Shape loss on cutting” was evaluated by checking the shape of rectangular cut pieces; A indicates that all the pieces were cut neatly, B that all the pieces were cut without the loss of shape, C that almost all the pieces were cut without the loss of shape, D that half of the pieces lost the shape and E that almost all the pieces lost the shape.

“Softness” of the food was evaluated by checking softness of the sample taken out at fridge temperature about 5° C. and eating it; A indicates that the food was very soft, B that it was soft, C that it was almost like the normal bean curd, D that it was harder than the normal bean curd and E that it was very hard.

“Granular unpleasant feeling” was evaluated by checking whether there was any granular or crispy mouthfeel on eating the sample taken out at about fridge temperature about 5° C.; A indicates that there was no unpleasant feeling at all, B that there was no unpleasant feeling, C that the unpleasant feeling could not be felt, D that there was unpleasant feeling and E that there was strong unpleasant feeling.

“Presence of the pithy tissue” was evaluated by checking the “pithy tissue” (air bubbles) in the bean curd visually and by feeling on the tongue; A indicates that there was no “pithy tissue” at all, B indicates that there was almost no “pithy tissue”, C indicates that there was slightly “pithy tissue”, D indicates that there was “pithy tissue” and E indicates that there was many “pithy tissue”.

“Overall taste” was evaluated on the basis of complete impression about the sample; A, B, C, D and E correspond to very good, good, normal, bad and very bad respectively.

TABLE 1

| | | | | | Milk serum | | | | |
|---|---|---|---|---|---|---|---|---|---|
| | Soymilk | | | | protein | | | | |
| | solid | | Yam | WPC from | (Acid whey | Egg | | guar | Thick. |
| | component | Starch | powder | cheese whey | conc. WPC) | albumin | Gelatin | gum | (mm) |
| Embodiment 1 | 12.5 | 2.9 | 0.06 | 1.00 | 1.00 | 0.06 | 0.50 | 0.50 | 20 |
| Embodiment 2 | 11.0 | 2.9 | 0.06 | 0.90 | 1.00 | 0.06 | 0.50 | 0.50 | 20 |
| Embodiment 3 | 12.5 | 2.9 | 0.06 | 0.80 | 0 | 0.06 | 0 | 0.50 | 20 |
| Embodiment 4 | 12.5 | 2.9 | 0.06 | 0 | 0 | 0.06 | 0.50 | 0.50 | 20 |
| Embodiment 5 | 12.5 | 2.2 | 0 | 1.00 | 0 | 0 | 0.50 | 0.50 | 20 |
| Embodiment 6 | 12.5 | 3.2 | 0.09 | 0.5 | 1.50 | 0.09 | 0.50 | 0.08 | 18 |
| Embodiment 7 | 12.5 | 2.9 | 0.06 | 0.5 | 0.50 | 0.06 | 0.50 | 0.50 | 18 |
| Embodiment 8 | 12.5 | 3.6 | 0.12 | 0.4 | 0.50 | 0.12 | 0.50 | 0.10 | 18 |
| Embodiment 9 | 12.5 | 2.9 | 0.06 | 0.1 | 0 | 0.06 | 0.50 | 0.50 | 18 |
| Embodiment 10 | 12.5 | 2.9 | 0.06 | 0.2 | 0 | 0 | 0.50 | 0.50 | 18 |
| Embodiment 11 | 12.5 | 2.9 | 0 | 0.06 | 1.00 | 0.06 | 0.50 | 0.50 | 20 |
| Comparative | 12.5 | 2.9 | — | — | — | — | 0.50 | 0.50 | 18 |
| Exemple | | | | | | | | | |

TABLE 2

| | | | Foreign | Presence | | | | | Foreign | Presence | |
|---|---|---|---|---|---|---|---|---|---|---|---|
| | Shape | | granules | of pithy | Overall | FD | | | granules | of pithy | Overall |
| | loss on | Softness | feeling | tissue | taste | dryness | Cracks | Softness | feeling | tissue | taste |
| | cutting | Freezing | Freezing | Freezing | Freezing | FD | FD | FD | FD | FD | FD |
| Embodiment 1 | A | A | A | A | A | A | A | B | A | B | A |
| Embodiment 2 | A | A | A | A | A | A | A | B | A | B | A |
| Embodiment 3 | B | A | A | A | B | A | B | B | A | B | A |
| Embodiment 4 | B | A | A | A | B | A | B | B | A | B | B |
| Embodiment 5 | B | A | A | A | B | A | B | B | A | B | B |
| Embodiment 6 | A | A | A | A | A | A | A | B | A | B | A |
| Embodiment 7 | A | A | A | A | A | A | A | A | A | B | A |
| Embodiment 8 | A | A | A | A | A | A | A | A | A | B | A |
| Embodiment 9 | A | A | A | A | A | A | A | B | A | B | A |
| Embodiment 10 | C | A | A | A | B | A | C | B | A | B | B |
| Embodiment 11 | A | A | A | A | A | A | A | B | A | B | A |
| Comparative | C | C | A | A | C | A | C | D | A | C | D |
| Exemple | | | | | | | | | | | |

According to the above description, the bean curd of this invention has excellent forming characteristics and is capable of effectively preventing the modifications, etc., due to freeze-up (lyophilization). Moreover, it exhibits excellent smoothness or the like and mouthfeel even on restoration to its original state by thawing, etc., after preservation.

1. An ingredient for food containing soybean component produced by mixing a thickening treatment agent derived from yam belonging to Dioscoreacea and/or a thickening heat treatment agent derived from cheese whey with soymilk-like liquid.

2. An ingredient for food containing soybean component produced by mixing a thickening treatment agent derived from yam belonging to Dioscoreacea and/or a thickening heat treatment agent derived from cheese whey and a shape loss preventing agent derived from an animal protein with soymilk-like liquid.

3. A food containing soybean component, which can be preserved by freeze-up, produced by mixing a soymilk coagulant capable of coagulating the soymilk-like liquid and a gelling agent capable of gelation of soybean curd components on cooling, a thickening treatment agent derived from yam belonging to Dioscoreacea and/or a thickening heat treatment agent derived from cheese whey with soymilk-like liquid, thereafter heating the mixture to coagulation temperature of the soymilk coagulant or higher and finally cooling the mixture.

4. A food containing soybean component, which can be preserved by freeze-up, produced by mixing a soymilk coagulant capable of coagulating the soymilk-like liquid and a gelling agent capable of gelation of soybean curd components on cooling, a thickening treatment agent derived from yam belonging to Dioscoreacea and/or a thickening heat treatment agent derived from cheese whey, and a shape loss preventing agent derived from an animal protein with soymilk-like liquid, thereafter heating the mixture to coagulation temperature of the soymilk coagulant or higher and finally cooling the mixture.

5. The food containing soybean component according to claim 3, which can be preserved by freeze-up, wherein the thickening treatment agent derived from yam belonging to Dioscoreacea is yam component.

6. The food containing soybean component according to claim 3, which can be preserved by freeze-up, wherein the thickening heat treatment agent derived from cheese whey corresponds to whey protein concentrate (WPC) derived from cow's milk which is heat coagulating protein.

7. The food containing soybean component according to claim 4, which can be preserved by freeze-up, wherein the shape loss preventing agent derived from an animal protein is milk serum protein or egg albumin component.

8. The food containing soybean component according to claim 3, which can be preserved by freeze-up, wherein the soymilk-like liquid contains 6% or more, preferably 8% to 20% solid soybean component.

9. The food containing soybean component which can be preserved by freeze-up according to claim 3, wherein the soymilk coagulant contains at least one of calcium sulfate, SUMASHI-KO including calcium sulfate as the main component, calcium chloride, magnesium chloride, bittern having magnesium chloride as the main component, gluconodeltalactone and lactic acid.

10. The food containing soybean component according to claim 3, which can be preserved by freeze-up, wherein the gelling agent contains at least one of proteins such as gelatin, etc., seaweed polysaccharide, sap polysaccharide, seed polysaccharide, and the polysaccharide derived from microbial source.

11. The food containing soybean component according to claim 4, which can be preserved by freeze-up, comprising 100 wt % of soymilk-like liquid, 0.01 to 0.08 wt %, preferably 0.05 to 0.3 wt % of a soymilk coagulant, 0.05 to 4 wt %, preferably 0.1 to 2 wt % of a gelling agent, 0.01 to 4 wt %, preferably 0.04 to 2 wt % of a thickening treatment agent derived from yam belonging to Dioscoreacea, 0.01 to 4 wt %, preferably 0.04 to 2 wt % of a thickening heat treatment agent derived from cheese whey, and 0.01 to 3 wt %, preferably 0.03 to 2 wt % of a shape loss preventing agent derived from an animal protein at weight of solid in dry state.

12. The food containing soybean component according to claim 4, which can be preserved by freeze-up, comprising 100 wt % of soymilk-like liquid, 0.3 to 0.8 wt %, preferably 0.4 to 0.6 wt % of soymilk coagulant, 0.05 to 4 wt %, preferably 0.1 to 2 wt % of a gelling agent, 0.1 to 3 wt %, preferably 0.5 to 2 wt % of a thickening treatment agent derived from yam belonging to Dioscoreacea, 0.5 to 15 wt %, preferably 1 to 8 wt % of a thickening heat treatment agent derived from cheese whey, and 0.5 to 5 wt %, preferably 1 to 3 wt % of a shape loss preventing agent derived from an animal protein weight of solid in dry state.

13. A method for producing food containing soybean component, which can be preserved by freeze-up comprising the steps of;
heating soymilk-like liquid to a temperature condition of 41 to 69° C.,
mixing a soymilk coagulant capable of coagulating the soymilk-like liquid and a gelling agent capable of gelation of soybean curd components on cooling with the soymilk-like liquid under the temperature condition, and
adding a thickening treatment agent derived from yam belonging to Dioscoreacea and/or a thickening heat treatment agent derived from cheese whey at the temperature condition, and
heating the mixture of the soymilk coagulant or higher then cooling the mixture.

14. A method for producing food containing soybean component, which can be preserved by freeze-up, comprising the steps of;
heating soymilk-like liquid to a temperature condition of 41 to 69° C.,
mixing a soymilk coagulant capable of coagulating the soymilk-like liquid and a gelling agent capable of gelation of soybean curd components on cooling with the soymilk-like liquid under the temperature condition, and
mixing a thickening treatment agent derived from yam belonging to Dioscoreacea and/or a thickening heat treatment agent derived from cheese whey and a shape loss preventing agent derived from an animal protein under the temperature condition, whether the mixture is heated to coagulation temperature of the soymilk coagulant or higher and finally the hot mixture is cooled.

15. A food containing soybean component, obtained by mixing ingredients of CHAWAN MUSHI with the food product containing a soybean component according to claim 3.

16. A food containing soybean component, obtained by mixing at least one of fruit, fruit juice and dairy products with the food product containing soybean component according to claim 3.

17. A food containing soybean component, obtained by mixing chicken mince, salt, bread crumb, onion, white pepper, garlic, and albumin with the food product containing soybean component according to claim 3 and then molding and frying the resultant mixture.

18. A food containing soybean component, obtained by mixing beef mince, onion, bread crumb, starch, sugar, salt, pepper, and nutmeg to the food product containing soybean component according to claim 3 and then roasting, steaming and sterilized the resultant mixture by heating.

19. A food containing soybean component, obtained by mixing beef mince, onion, bread crumb, starch, sugar, salt, pepper, and nutmeg to the food product containing soybean component according to claim 3 and then roasting, steaming and sterilized the resultant mixture by heating.

20. A food containing soybean component, obtained by mixing beef mince, onion, bread crumb, starch, sugar, salt, pepper, and nutmeg to the food product containing soybean component according to claim 3 and then applying butter and bread crumb to the resultant product.

21. A food containing soybean component, obtained by powdering then applying a butter to the food product of a fixed shape containing soybean component according to claim 3 and then pre-frying the resultant product.

22. A food containing soybean component, obtained by powdering then applying and a butter to the food product of a fixed shape containing soybean component according to claim 3.

23. A food containing soybean component, obtained by soaking the food product of a fixed shape containing soybean component according to claim 3 in salt water, draining liquid from it, frying and then draining oil.

24. A food containing soybean component, obtained by roasting the food product of a fixed shape including soybean component according to claim 3 then applying a sauce including butter, garlic, red pepper, maitake, edible mushroom, and soy sauce.

25. A food containing soybean component, obtained by mixing medium-strength powder and salt water with the food containing soybean component according to claim 1 as an ingredient, cutting the resultant product to desired thickness and width, and boiling then cooling the product.

26. A food containing soybean component, obtained by mixing strong powder, medium-strength powder, weak powder, salt water and olive oil with the food containing soybean component according to claim 1 as ingredient, cutting the resultant product to the desired thickness and width and boiling then cooling the product.

27. A food containing soybean component, obtained by mixing medium-strength powder, salt water and KANSUI with the food containing soybean component according to claim 1 as ingredient, cutting the resultant product to desired thickness and width, and boiling then cooling the product.

28. A food containing soybean component, obtained by mixing a mixture made by adding sugar to beaten egg albumin, mixing with beaten fresh cream with the food containing soybean component according to claim 1 as ingredient, pouring the resultant mixture in a container then freezing.
